(19) United States
(12) Patent Application Publication
(10) Pub. No.: US 2026/0368831 A1
(43) Pub. Date: Nov. 19, 2026

(54) SYSTEM AND METHOD FOR AUTOMATICALLY PREDICTING INVOICES TO BE MARKED AS CLOSED FOR PAYMENTS RECEIVED

(71) Applicant: HIGHRADIUS CORPORATION, Houston, TX (US)

(72) Inventors: Debanwesh Bose, Hyderabad (IN); Ansumun Gouda, Hyderabad (IN); Sujatro Baral, Hyderabad (IN); Siddharth Dutta, Hyderabad (IN); Lohit Vankina, Hyderabad (IN); Yagnesh Prakash Chawhan, Hyderabad (IN)

(21) Appl. No.: 19/208,640

(22) Filed: May 15, 2025

(51) Int. Cl. G06Q 40/12; G06Q 30/04

(52) U.S. Cl. CPC G06Q 40/12; G06Q 30/04

(57) ABSTRACT

A machine learning based (ML-based) method and system for automatically predicting invoices to be marked as closed for payments received from entities, is disclosed. The process begins by obtaining data associated with financial information of the entities, from data sources. The process is followed by extracting datasets from the data of the entities. For each entity, historical data are generated including at least one of: historical payment records and invoices that were open at the time the payments received from the entities. The historical data are pre-processed to generate pre-processed data for training a ML-model. The ML-model trained on the pre-processed data, is employed to predict the invoices to be marked as closed for the payments. The invoices to be marked as closed for the payments received, are provided as an output, to users on user interfaces associated with electronic devices associated with the users.

### FIELD OF INVENTION

Embodiments of the present disclosure relate to machine learning based (ML-based) systems, and more particularly relates to a ML-based method and system for automatically predicting one or more invoices to be marked as closed for one or more payments received from one or more entities.

### BACKGROUND

It is a common practice for entities, particularly customers, buyers, consumers, patrons, clients, and purchasers, to include remittance advice when submitting payments. This remittance advice outlines which specific invoices the payment is intended to cover. However, not all entities provide these details, which can create setbacks and inefficiencies during the reconciliation process. As a result, finance teams are often required to manually review payment records, transaction histories, and open invoices to determine which ones have likely been settled and should be marked as paid.

Conventional systems utilize traditional rule-based approaches to predict which invoices should be marked as closed when the remittance advice details are missing. The key challenge for such conventional systems is deciding which open invoices can be closed for the payments without the remittance advice details. In a real-world scenario, payments are received from multiple entities, but without explicit and clear remittance advice, it becomes difficult to determine which invoices have been settled.

The traditional rule-based approaches fail to manage the complexity of real-world payment behaviors, including at least one of: entities making payments in bulk that cover multiple invoices, payments that are sometimes exactly equal to the invoice amounts and other times they are nearly but not exactly equal to the invoice amounts due to factors such as currency differences, deductions, rounding errors, delayed payments, and due to customers who often forget to send remittance advice, making it difficult for the traditional rule-based approaches to establish a matching pattern, where an invoice might be marked as unpaid even though the payment has actually been received.

Hence, there is a need for an improved machine learning based (ML-based) system and method for automatically predicting one or more invoices to be marked as closed for one or more payments received from one or more entities, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) method for automatically predicting one or more invoices to be marked as closed for one or more payments received from one or more entities, is disclosed. The ML-based method further comprises obtaining, by one or more hardware processors, data associated with financial information of the one or more entities, from one or more data sources.

The ML-based method further comprises extracting, by the one or more hardware processors, one or more datasets from the data of the one or more entities.

The ML-based method further comprises for each entity, generating, by the one or more hardware processors, historical data comprising at least one of: one or more historical payment records and one or more invoices that were open at the time the one or more payments received from the one or more entities.

The ML-based method further comprises pre-processing, by the one or more hardware processors, the historical data to generate pre-processed data for training a ML-model.

The ML-based method further comprises predicting, by the one or more hardware processors, the one or more invoices to be marked as closed for the one or more payments received from the one or more entities, using the ML-model trained on the pre-processed data.

The ML-based method further comprises providing, by the one or more hardware processors, the one or more invoices to be marked as closed for the one or more payments received, as an output, to one or more users on one or more user interfaces associated with one or more electronic devices associated with the one or more users.

In an embodiment, generating the historical data comprises: (a) extracting, by the one or more hardware processors, the one or more invoices that were open on or before payment date for each payment received from the one or more entities; (b) for each invoice, determining, by the one or more hardware processors, whether at least one of: the invoice date is on or before the payment date, and a recorded payment date is later than or equal to a payment due date; (c) adding, by the one or more hardware processors, the one or more invoices in the historical data upon determining whether at least one of: the invoice date is on or before the payment date, and the recorded payment date is greater than or equal to the payment due date; and (d) assigning, by the one or more hardware processors, one or more labels on the one or more invoices based on matching of one or more payment header identifiers associated with the one or more invoices, with one or more payment identifiers associated with the one or more payments received from the one or more entities. The one or more invoices are labelled as one or more closed invoices when the payment header identifiers match with the one or more payment identifiers. The one or more invoices are labelled as one or more open invoices when the payment header identifiers do not match with the one or more payment identifiers.

In another embodiment, generating the pre-processed data comprises generating, by the one or more hardware processors, one or more subsets of the one or more invoices, by: (a) extracting, by the one or more hardware processors, the one or more invoices that were open at the time the one or more payments received from the one or more entities; (b) identifying, by the one or more hardware processors, one or more combinations of the one or more invoices using a subset sum model, to obtain the one or more subsets having the identified one or more combinations of the one or more invoices; (c) selecting, by the one or more hardware processors, one or more optimized subsets from the one or more subsets based on a condition that a total sum of the one or more invoices within each of the one or more subsets is equal to the one or more payments received from the one or more entities, wherein one or more predefined rules are applied to select the one or more optimized subsets when multiple subsets of the one or more subsets fulfil the condition; (d) mapping, by the one or more hardware processors, one or more payment header identifiers associated with the selected one or more optimized subsets of the one or more invoices with the one or more payment identifiers associated with the one or more payments received from the one or more entities to validate whether the selected one or more optimized subsets of the one or more invoices match the one or more payments; and (e) labelling, by the one or more hardware processors, the one or more invoices in the one or more subsets, as closed when the one or more invoices in the one or more subsets are matched with the one or more payment identifiers.

In yet another embodiment, generating the pre-processed data further comprises extracting, by the one or more hardware processors, one or more features for each subset of the one or more invoices, from the historical data to train the ML model to learn one or more patterns corresponding to at least one of: the one or more payments and the one or more invoices closed for the one or more payments, and provide one or more insights. The one or more insights comprise at least one of: one or more payment behaviors patterns of the one or more entities, one or more grouping patterns associated with grouping of the one or more invoices, one or more delay trends, and variability in payments. The one or more features comprise at least one of: one or more customer-level features and one or more subset-level features.

In yet another embodiment, the ML-based method further comprises: (a) integrating, by the one or more hardware processors, information associated with the one or more features of the one or more subsets to determine the one or more optimized subsets; and (b) utilizing, by the one or more hardware processors, the integrated information for training the ML model to predict the one or more invoices to be marked as closed for the one or more payments received from the one or more entities.

In yet another embodiment, the ML-based method further comprises training, by the one or more hardware processors, the ML model, by: (a) splitting, by the one or more hardware processors, the one or more datasets associated with the one or more entities into at least one of: one or more training datasets and one or more testing datasets; and (b) training, by the one or more hardware processors, the ML model on the one or more training datasets to learn the one or more patterns corresponding to invoice-payment mappings, using one or more hyperparameters. The one or more hyperparameters comprises at least one of: n estimators indicating a number of trees in a forest model, a random state for result reproducibility, a class weight for learning invoice-payment mappings, an optimum depth to prevent overfitting, and an optimum feature to ensure diversity in decision-making.

In yet another embodiment, the ML-based method further comprises evaluating, by the one or more hardware processors, performance of the ML model in predicting the one or more invoices to be marked as closed for the one or more payments received from the one or more entities, by: (a) assigning, by the one or more hardware processors, one or more probability scores to each subset of the one or more invoices; (b) selecting, by the one or more hardware processors, a subset with an optimum probability score as the predicted invoice for the payments; and (c) assessing, by the one or more hardware processors, an accuracy of the ML model, based on a number of correctly predicted payments and a total number of payments.

In yet another embodiment, the ML-based method further comprises: (a) generating, by the one or more hardware processors, one or more evaluation reports providing one or more insights into the accuracy of performance of the ML model, wherein the one or more evaluation reports indicate at least one of: one or more error patterns, and error distribution across the one or more entities, and wherein the one or more evaluation reports are configured to identify types and sources of errors; (b) automatically generating, by the one or more hardware processors, one or more feedback in at least one of: real-time and periodic, on the one or more evaluation reports to provide one or more suggestions on the invoice-payment mapping process; and (c) monitoring, by the one or more hardware processors, performance of the ML model over time to determine one or more changes in accuracy metrics and error patterns.

In one aspect, a machine learning based (ML-based) system for automatically predicting one or more invoices to be marked as closed for one or more payments received from one or more entities, is disclosed. The ML-based system includes one or more hardware processors and a memory coupled to the one or more hardware processors. The memory includes a plurality of subsystems in the form of programmable instructions executable by the one or more hardware processors.

The plurality of subsystems comprises a data obtaining subsystem configured to obtain data associated with financial information of the one or more entities, from one or more data sources.

The plurality of subsystems further comprises a data extracting subsystem configured to extract one or more datasets from the data of the one or more entities.

The plurality of subsystems further comprises a data generating subsystem configured to generate historical data for each entity, which comprise at least one of: one or more historical payment records and one or more invoices that were open at the time the one or more payments received from the one or more entities.

The plurality of subsystems further comprises a data pre-processing subsystem configured to pre-process the historical data to generate pre-processed data for training a ML-model.

The plurality of subsystems further comprises an invoice predicting subsystem configured to predict the one or more invoices to be marked as closed for the one or more payments received from the one or more entities, using the ML-model trained on the pre-processed data.

The plurality of subsystems further comprises an output subsystem configured to provide the one or more invoices to be marked as closed for the one or more payments received, as an output, to one or more users on one or more user interfaces associated with one or more electronic devices associated with the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) system for automatically predicting one or more invoices to be marked as closed for one or more payments received from one or more entities, in accordance with an embodiment of the present disclosure;

FIG. 2 is a detailed view of the ML-based system for automatically predicting the one or more invoices to be marked as closed for the one or more payments received from the one or more entities, in accordance with another embodiment of the present disclosure;

FIG. 3 is a tabular view depicting one or more datasets being extracted for analyzing payment patterns to predict which invoices should be closed when the remittance advice is missing, in accordance with another embodiment of the present disclosure;

FIG. 4 is a tabular view depicting historical data, in accordance with another embodiment of the present disclosure;

FIG. 5 is a tabular view depicting one or more subsets generated to train the ML-model to automate future invoice closure predictions, in accordance with another embodiment of the present disclosure;

FIG. 6 is a tabular view depicting validated one or more subsets, in accordance with another embodiment of the present disclosure;

FIG. 7 is a tabular view depicting integrated information associated with one or more features of the one or more subsets utilized for training the ML-model, in accordance with another embodiment of the present disclosure;

FIG. 8 is a tabular view depicting the predicted one or more invoices for each payment received from the one or more entities, in accordance with another embodiment of the present disclosure; and

FIG. 9 is a flow chart illustrating a machine-learning based (ML-based) method for automatically predicting the one or more invoices to be marked as closed for the one or more payments received from the one or more entities, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

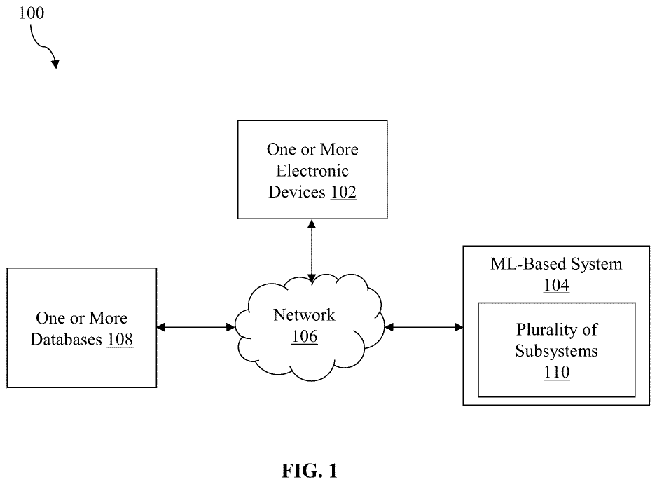

Referring now to the drawings, and more particularly to FIG. 1 through FIG. 9, where similar reference characters denote corresponding features consistently throughout the figures, there are shown preferred embodiments, and these embodiments are described in the context of the following exemplary system and/or method.

FIG. 1 is a block diagram illustrating a computing environment 100 with a machine learning based (ML-based) system 104 for automatically predicting one or more invoices to be marked as closed for one or more payments received from one or more entities, in accordance with an embodiment of the present disclosure. According to FIG. 1, the computing environment 100 includes one or more electronic devices 102 that are communicatively coupled to the ML-based system 104 through a network 106. The one or more electronic devices 102 through which one or more users receive output results from the ML-based system 104.

The present invention is configured to automatically predict one or more invoices to be marked as closed for one or more payments received from one or more entities. The ML-based system 104 is initially configured to obtain data associated with financial information of the one or more entities, from one or more data sources (e.g., one or more databases 108). The ML-based system 104 is further configured to extract one or more datasets from the data of the one or more entities. In an embodiment, the one or more datasets may be encrypted and decrypted by the ML-based system 104, so that one or more third party users cannot be authenticated to manipulate the one or more datasets.

The ML-based system 104 is further configured to generate historical data for each entity, which comprise at least one of: one or more historical payment records and one or more invoices that were open at the time the one or more payments received from the one or more entities. The ML-based system 104 is further configured to pre-process the historical data to generate pre-processed data for training a ML-model.

The ML-based system 104 is further configured to predict the one or more invoices to be marked as closed for the one or more payments received from the one or more entities, using the ML-model trained on the pre-processed data. The ML-based system 104 is further configured to provide the one or more invoices to be marked as closed for the one or more payments received, as an output, to the one or more users on one or more user interfaces associated with the one or more electronic devices 102 associated with the one or more users.

In an embodiment, the one or more users may include at least one of: one or more data analysts, one or more business analysts, one or more cash analysts, one or more financial analysts, one or more collection analysts, one or more debt collectors, and one or more professionals associated with cash and collection management, and the like. In an embodiment, the data associated with financial information may include at least one of: invoice dates, payment statuses, amounts due, payment methods, transaction references, due dates, payment header identifiers associated with the one or more invoices, payment identifiers associated with the one or more payments received from one or more entities, description of services or goods, tax amounts, discounts applied, currency types, payment processing dates, overdue amounts, remittance information, account numbers, any relevant notes or comments and the like.

In an embodiment, the one or more entities may include at least one of: one or more customers, one or more buyers, one or more patrons, one or more clients, one or more purchasers, one or more organizations, one or more corporations, one or more parent companies, one or more subsidiaries, one or more joint ventures, one or more partnerships, one or more governmental bodies, one or more associations, and one or more legal entities, and the like.

The ML-based system 104 may be hosted on a central server including at least one of: a cloud server or a remote server. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes the one or more databases 108 communicatively coupled to the ML-based system 104 through the network 106. In an embodiment, the one or more databases 108 may store the one or more datasets. In an embodiment, the one or more databases 108 may include at least one of: one or more relational databases, one or more object-oriented databases, one or more data warehouses, one or more cloud-based databases, and the like. In another embodiment, a format of the data obtained from the one or more documents may include at least one of: a comma-separated values (CSV) format, a JavaScript Object Notation (JSON) format, an Extensible Markup Language (XML), spreadsheets, and the like.

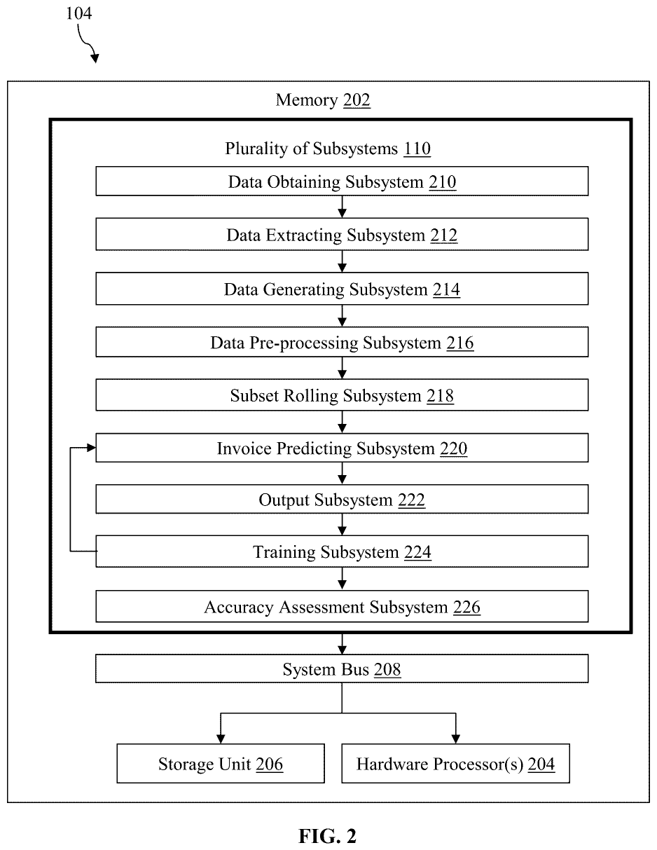

Furthermore, the one or more electronic devices 102 include at least one of: a local browser, a mobile application, and the like. Furthermore, the one or more users may use a web application through the local browser, the mobile application to communicate with the ML-based system 104. In an embodiment of the present disclosure, the ML-based system 104 includes a plurality of subsystems 110. Details on the plurality of subsystems 110 have been elaborated in subsequent paragraphs of the present description with reference to FIG. 2.

FIG. 2 is a detailed view of the ML-based system 104 for automatically predicting the one or more invoices to be marked as closed for the one or more payments received from the one or more entities, in accordance with another embodiment of the present disclosure. The ML-based system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes a data obtaining subsystem 210, a data extracting subsystem 212, a data generating subsystem 214, a data pre-processing subsystem 216, a subset rolling subsystem 218, an invoice predicting subsystem 220, an output subsystem 222, a training subsystem 224, and an accuracy assessment subsystem 226. The brief details of the plurality of subsystems 110 have been elaborated in a below table.

| Plurality of | |
|---|---|
| Subsystems | |
| 110 | Functionality |
| Data obtaining | The data obtaining subsystem 210 is configured to obtain the data |
| subsystem 210 | associated with the financial information of the one or more |
| | entities, from the one or more data sources (e.g., the one or more |
| | databases 108). |
| Data extracting | The data extracting subsystem 212 is configured to extract the |
| subsystem 212 | one or more datasets from the data of the one or more entities. |
| Data | The data generating subsystem 214 is configured to generate the |
| generating | historical data for each entity, which comprise at least one of: the |
| subsystem 214 | one or more historical payment records and the one or more |
| | invoices that were open at the time the one or more payments |
| | received from the one or more entities. |
| Data pre- | The data pre-processing subsystem 216 is configured to pre- |
| processing | process the historical data to generate the pre-processed data for |
| subsystem 216 | training the ML-model. |
| Subset rolling | The subset rolling subsystem 218 is configured to generate the |
| subsystem 218 | one or more subsets of the one or more invoices. |
| Invoice | The invoice predicting subsystem 220 is configured to predict |
| predicting | the one or more invoices to be marked as closed for the one or |
| subsystem 220 | more payments received from the one or more entities, using |
| | the ML-model trained on the pre-processed data. |
| Output | The output subsystem 222 is configured to provide the one or |
| subsystem 222 | more invoices to be marked as closed for the one or more |
| | payments received, as the output, to the one or more users on |
| | the one or more user interfaces associated with the one or more |
| | electronic devices 102 associated with the one or more users. |
| Training | The training subsystem 224 is configured to train the ML |
| subsystem 224 | model. |
| Accuracy | The accuracy assessment subsystem 226 is configured to |
| assessment | evaluate performance of the ML model in predicting the one or |
| subsystem 226 | more invoices to be marked as closed for the one or more |
| | payments received from the one or more entities. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a NoSQL database or a location on a file system directly accessible by the plurality of subsystems 110.

The plurality of subsystems 110 includes the data obtaining subsystem 210 that is communicatively connected to the one or more hardware processors 204. The data obtaining subsystem 210 is configured to obtain the data associated with the financial information of the one or more entities, from the one or more data sources (i.e., the one or more databases 108).

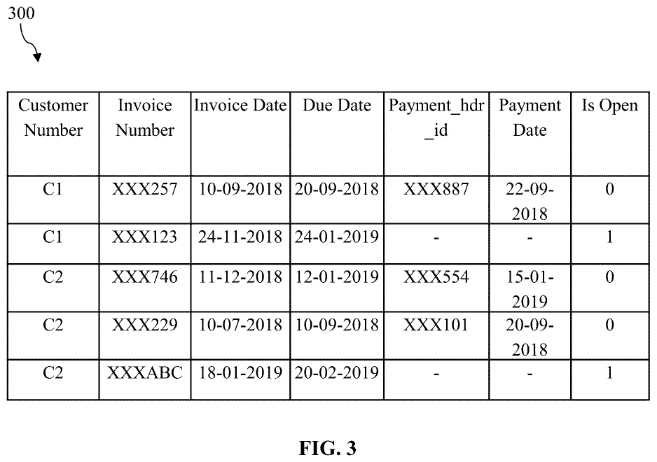

The plurality of subsystems 110 further includes the data extracting subsystem 212 that is communicatively connected to the one or more hardware processors 204. In an embodiment, the extracted one or more datasets may include one or more entities, wherein each entity may include a list of invoices. The extracted one or more datasets may be organized in any formats (for e.g., a tabular format as shown in FIG. 3).

The plurality of subsystems 110 includes the data generating subsystem 214 that is communicatively connected to the one or more hardware processors 204. The data generating subsystem 214 is configured to generate the historical data for each entity, comprising at least one of: the one or more historical payment records and the one or more invoices that were open at the time the one or more payments received from the one or more entities. In an embodiment, the generation of the historical data for each entity, allows the ML model to learn from past instances where invoices were successfully closed by the one or more payments, and to use the pattern to predict missing remittance mappings.

For generating the historical data, the data generating subsystem 214 is configured to extract the one or more invoices that were open on or before payment date for each payment received from the one or more entities. The data generating subsystem 214 is further configured to, for each invoice, determine whether at least one of: the invoice date is on or before the payment date, and a recorded payment date is later than or equal to a payment due date, which ensures that only valid invoices (the invoices that could have been closed by the payment) are considered. The data generating subsystem 214 is further configured to apply inclusion criteria. The data generating subsystem 214 is further configured to add the one or more invoices in the historical data upon determining whether at least one of: the invoice date is on or before the payment date, and the recorded payment date is greater than or equal to the payment due date.

The data generating subsystem 214 is further configured to assign one or more labels on the one or more invoices based on matching of one or more payment header identifiers associated with the one or more invoices, with one or more payment identifiers associated with the one or more payments received from the one or more entities. In an embodiment, the one or more invoices are labelled as one or more closed invoices when the payment header identifiers match with the one or more payment identifiers. The one or more invoices are labelled as one or more open invoices when the payment header identifiers do not match with the one or more payment identifiers.

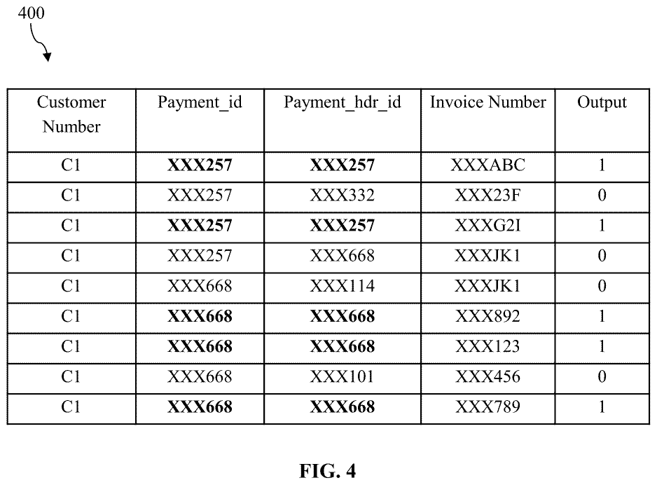

In an embodiment, a single payment event (having a payment identifier also referred as Payment ID) can be linked to multiple invoices. Each invoice has a Payment Header ID, which must match the Payment ID for the invoice to be considered closed. As illustrated in FIG. 4, if the Payment Header ID matches the Payment ID, the invoice is marked as closed (Output=1). If the Payment Header ID does not match the Payment ID, the invoice remains open (Output=0).

The data generating subsystem 214 is further configured to exclude one or more irrelevant invoices when the one or more payment header identifiers do not match with the one or more payment identifiers. The one or more irrelevant invoices are excluded from the one or more historical data to avoid introducing incorrect mappings into the training process of the ML model.

In an embodiment, the algorithm for the generation of the historical data is as follows.

```
If (Invoice Date <= Payment Date) & (is Open == 1):
  Include Invoice
Elif (Invoice Date <= Payment Date) &
(Invoice_Payment_Date >= Payment Date):
  Include Invoice
Else:
  Exclude Invoice
```

The plurality of subsystems 110 further includes the data pre-processing subsystem 216 that is communicatively connected to the one or more hardware processors 204. The data pre-processing subsystem 216 is configured to pre-process the historical data to generate pre-processed data for training the ML-model. For generating the pre-processed data, the data pre-processing subsystem 216 is configured to generate the one or more subsets of the one or more invoices. Since, a single payment may possibly correspond to multiple invoices, the data pre-processing subsystem 216 is configured to determine valid subsets of invoices whose total amount exactly matches the payment amount. A subset sum model is used to generate possible invoice combinations, ensuring that the one or more payments are fully allocated without over matching or under matching.

For generating the one or more subsets of the one or more invoices, the data pre-processing subsystem 216 is initially configured to extract the one or more invoices that were open at the time the one or more payments received from the one or more entities. These one or more invoices that were open, may serve as potential candidates for forming valid subsets. The data pre-processing subsystem 216 is further configured to identify one or more combinations of the one or more invoices using the subset sum model, to obtain the one or more subsets having the identified one or more combinations of the one or more invoices. The subset sum model is configured to perform at least one of: (a) including an invoice in the one or more subsets, (b) excluding an invoice and exploring other options, and (c) checking whether the total sum of the one or more subset equals the one or more payments.

The data pre-processing subsystem 216 is further configured to select one or more optimized subsets from the one or more subsets based on a condition that a total sum of the one or more invoices within each of the one or more subsets is equal to the one or more payments received from the one or more entities. In an embodiment, one or more predefined rules are applied to select the one or more optimized subsets when multiple subsets of the one or more subsets fulfil the condition. The one or more predefined rules may include business guidelines and requirements, such as prioritizing earlier payment due dates, any specific limits in invoice amounts, strategic importance i.e., giving precedence to any products or services deemed strategically important to the user's business goals. In an embodiment, if the multiple subsets of the one or more invoices do not match the payment amount, then the invoice-payment mapping is flagged for manual review.

The data pre-processing subsystem 216 is further configured to map one or more payment header identifiers associated with the selected one or more optimized subsets of the one or more invoices with the one or more payment identifiers associated with the one or more payments received from the one or more entities to validate whether the selected one or more optimized subsets of the one or more invoices match the one or more payments. The data pre-processing subsystem 216 is further configured to label the one or more invoices in the one or more subsets, as closed when the one or more invoices in the one or more subsets are matched with the one or more payment identifiers. In an embodiment, the one or more datasets are updated to reflect the reconciliation.

In an embodiment of the present disclosure, for generating the pre-processed data, the data pre-processing subsystem 216 is further configured to validate whether the generated one or more subsets correctly map to the payments received from the one or more entities, to determine whether the one or more invoices are closed. The validation process involves checking the Payment Header ID and determining whether the invoice should be considered as successfully closed.

In an embodiment of the present disclosure, for generating the pre-processed data, the data pre-processing subsystem 216 is further configured to extract one or more features for each subset of the one or more invoices, from the historical data to train the ML model to learn one or more patterns corresponding to at least one of: the one or more payments and the one or more invoices closed for the one or more payments, and provide one or more insights. In an embodiment, the one or more insights may include at least one of: one or more payment behaviors patterns of the one or more entities, one or more grouping patterns associated with grouping of the one or more invoices, one or more delay trends, and variability in payments. By utilizing the one or more features, the ML model is configured to predict the better invoice closures when the remittance is missing.

In an embodiment, the one or more features include at least one of: one or more customer-level features and one or more subset-level features. The customer-level features may include an average of all delays feature that defines an average delay in the one or more payments for a given entity. The average of all delays feature is configured to determine whether the one or more entities makes the payments in at least one of: on time and delays. The customer-level features may further include an average of invoices closed feature that defines an average number of invoices closed per payment for the entity. The average of invoices closed feature is configured to identify whether the one or more entities tend to consolidate the payments across the one or more invoices.

The customer-level features may further include a payment count per quarter feature that defines a number of payments made by the entity in each quarter. The payment count per quarter feature is configured to capture one or more seasonal trends in the payments. The customer-level features may further include an invoice count per quarter feature that defines a number of invoices generated for the entity in each quarter. The invoice count per quarter feature is configured to identify whether the one or more entities follow a structured invoicing pattern.

The one or more subset-level features may include an average delay categorical feature that defines average delay for invoices in a subset. The average delay categorical feature is configured to assist the ML model to prioritize the one or more subsets having lower delays. The highest average delay gets the lowest feature values, and the lowest average delay gets the highest feature value. The one or more subset-level features may further include a variance categorical feature that defines variance of payment delays for invoices in a subset. The variance categorical feature is configured to determine consistency in the one or more payments. The highest variance gets the highest feature value and the lowest variance gets the lowest feature value.

The one or more subset-level features may further include a low medium high (LMH) bins cumulative feature that defines categorization of the one or more invoices based on their amounts. The low medium high bins cumulative feature is configured to capture distribution of one or more invoice amounts within the one or more subsets. The one or more subset-level features may further include a unique invoice count feature that defines a proportion of unique invoices in a subset. The unique invoice count feature is configured to adapt the ML model to determine the groupings of the one or more invoices frequently.

The plurality of subsystems 110 further includes the subset rolling subsystem 218 that is communicatively connected to the one or more hardware processors 204. The subset rolling subsystem 218 is configured to integrate information associated with the one or more features of the one or more subsets to determine the one or more optimized subsets. The subset rolling subsystem 218 is further configured to utilize the integrated information for training the ML model to predict the one or more invoices to be marked as closed for the one or more payments received from the one or more entities.

The plurality of subsystems 110 further includes the invoice predicting subsystem 220 that is communicatively connected to the one or more hardware processors 204. The invoice predicting subsystem 220 is configured to predict the one or more invoices to be marked as closed for the one or more payments received from the one or more entities, using the ML-model trained on the pre-processed data.

The plurality of subsystems 110 further includes the output subsystem 222 that is communicatively connected to the one or more hardware processors 204. The output subsystem 222 is configured to provide the one or more invoices to be marked as closed for the one or more payments received, as the output, to the one or more users on the one or more user interfaces associated with the one or more electronic devices 102 associated with the one or more users. In an embodiment, the output is returned back to a third party system calling an application programming interface (API) (e.g., a Certification Authority Authorization (CAA) Product) in the aforementioned output format with relevant metadata for their consumption. The output may be ingested in backend databases for performing CRUD operations i.e., Create, Read, Update, and Delete operations, and further processing

The plurality of subsystems 110 further includes the training subsystem 224 that is communicatively connected to the one or more hardware processors 204. The training subsystem 224 is configured to train the ML model. For training the ML model, the training subsystem 224 is initially configured to obtaining one or more datasets associated with the financial information of the one or more entities. The one or more datasets are split into at least one of: one or more training datasets and one or more testing datasets, while ensuring that each entity's data is distributed properly.

For example, 70 percent of each entity's data is allocated to the one or more training datasets, and 30 percent of each entity's data is allocated to the one or more testing datasets, which ensures that the ML model learns customer-specific payment behaviors while being tested on unseen cases. In an embodiment, the ML model selected for invoice-payment matching is the Random Forest Classifier model, which is a powerful and widely used ensemble learning model. The Random Forest Classifier model is particularly effective for handling non-linear relationships, missing data, and complex decision-making processes, making it an ideal choice for predicting invoice closures based on the remittances. The Random Forest Classifier model works by constructing multiple decision trees during training and combining their predictions to make a final decision. This approach reduces overfitting and increases accuracy, ensuring that the Random Forest Classifier model generalizes well to unseen invoice-payment scenarios. In an embodiment, the ML model may be at least one of: Logistic Regression model, Support Vector Machine (SVM) model, k-Nearest Neighbors (k-NN) model, Neural Networks model, and the like.

The training subsystem 224 is initially configured to train the ML model on the one or more training datasets to learn the one or more patterns corresponding to invoice-payment mappings, using one or more hyperparameters. The one or more hyperparameters comprises at least one of: n estimators indicating a number of trees in a forest model, a random state for result reproducibility, a class weight for learning invoice-payment mappings, an optimum depth to prevent overfitting, and an optimum feature to ensure diversity in decision-making.

The one or more hyperparameters may include n estimators (otherwise referred as n_estimators=150) indicating the number of trees in the forest model. The higher values of the n estimators improves/enhances accuracy but increases training time. In an embodiment, 150 trees were selected as an optimal balance between performance and efficiency.

The one or more hyperparameters may further include random state (random state=42) that is configured to determine reproducibility of one or more results. The random state is configured to utilize the same random state allows consistency in model evaluation. The one or more hyperparameters may further include class weight (i.e., class weight={0:1, 1:2}) that is configured to be applied for the ML model to correctly learn the invoice-payment mappings, as the datasets has more incorrect subsets (output=0) than correct ones (output=1). In an embodiment, the correct matches (output=1) are given twice the weight of incorrect matches (output=0) to determine that the ML model correctly learns invoice-payment mappings.

The one or more hyperparameters may further include optimum depth (otherwise referred as maximum_depth=15) that is configured to limit depth of each decision tree to prevent overfitting. A maximum_depth of 15 was chosen to determine that trees do not grow too complex while still capturing meaningful patterns. The one or more hyperparameters may further include optimum features (otherwise referred as maximum_features=0.4) that is configured to restrict each tree to utilize available features determining diversity in decision-making. The maximum_features is configured to prevent overfitting by reducing the dependency of trees on any single feature.

The ML-model predicts probabilities of a subset belonging to a particular payment. Accordingly, the data is converted into one or more formats (e.g., a JSON format) for consumption and storage. For example:

```
“item Predictions”: [
  {
    “probability(0)”: 0.07225925925925926,
    “probability(1)”: 0.9277407407407406,
    “probability”: 0.9277407407407406,
    “probabilityDistribution”: [
      0.07225925925925926,
      0.9277407407407406
    ],
    “labels”: 1,
    “primaryKey”: “123:2”,
    “subset”: [
      {
        “invoice_number”: “123”,
        “invoice_amount”: 10.62,
        “invoice_date”: “2022-01-11”
      },
      {
        “invoice_number”: “124”,
        “invoice_amount”: 7.0,
        “invoice_date”: “2022-01-11”
      }
    ]
  }
]
```

The plurality of subsystems 110 further includes the accuracy assessment subsystem 226 that is communicatively connected to the one or more hardware processors 204. The accuracy assessment subsystem 226 is configured to evaluate performance of the ML model in predicting the one or more invoices to be marked as closed for the one or more payments received from the one or more entities. The accuracy assessment subsystem 226 is configured to assess how well the ML model predicts the correct invoice subsets for the one or more payments.

For evaluating the performance of the ML model, the accuracy assessment subsystem 226 is configured to assign one or more probability scores to each subset of the one or more invoices, for each entity and payment. The accuracy assessment subsystem 226 is further configured to select a subset with an optimum probability score as the predicted invoice for the payments by the ML model. If the predicted subset matches the correct subset, it is classified as a success case. The accuracy assessment subsystem 226 is further configured to assessing an accuracy of the ML model, based on a number of correctly predicted payments and by a total number of payments. The accuracy of the ML model is obtained by dividing the number of correctly predicted payments to the total number of payments.

The accuracy is a critical metric to determine the effectiveness of the ML model in correctly predicting the one or more subsets of the one or more invoices. The correctly predicted payment means that the ML model's selected subset matches the actual invoice subset used for closing the payment. The accuracy metric provides a direct measure of how reliable the ML model is in automating the invoice-payment mappings.

The accuracy assessment subsystem 226 is configured to generate one or more evaluation reports providing one or more insights into the accuracy of performance of the ML model. The one or more evaluation reports may indicate at least one of: one or more error patterns, and error distribution across the one or more entities. The one or more evaluation reports are configured to identify types and sources of errors. The one or more evaluation reports may include at least one of: one or more visualizations, one or more statistical summaries, and detailed error analysis, to facilitate a comprehensive understanding of the accuracy assessment results.

The accuracy assessment subsystem 226 is further configured to generate one or more feedback based on the one or more evaluation reports to provide one or more suggestions on the invoice-payment mapping process. The accuracy assessment subsystem 226 is configured to identify specific patterns or rules contributing to errors and provide actionable recommendations for refinement. The one or more feedback may include one or more suggestions for adjusting machine learning model parameters, data preprocessing techniques, feature selection, or other aspects of the remittance prediction pipeline.

The accuracy assessment subsystem 226 is further configured to automatically generate one or more feedback in at least one of: real-time and periodic, on the one or more evaluation reports to provide one or more suggestions on the invoice-payment mapping process. The accuracy assessment subsystem 226 is configured to integrate with the remittance prediction pipeline, automatically assessing accuracy, generating evaluation reports, and providing feedback without manual intervention. The accuracy assessment subsystem 226 is configured to support automation using APIs, event triggers, or workflow integration, ensuring timely and automated feedback incorporation into the data extraction process.

The accuracy assessment subsystem 226 is further configured to monitor performance of the ML model over time to determine one or more changes in accuracy metrics and error patterns. The accuracy assessment subsystem 226 is configured to enable comparisons between different iterations or versions of the machine learning model or input data pipeline to evaluate the impact of feedback and improvement efforts.

The plurality of subsystems 110 further includes the re-training subsystem that is communicatively connected to the one or more hardware processors 204. In an embodiment, the re-training subsystem is configured to re-train the ML model based on one or more feedback on the performance of the ML model, received from the one or more electronic devices 102 of the one or more users. In another embodiment, the re-training subsystem is configured to re-train the ML-model over a plurality of time intervals by adjusting the one or more hyperparameters, when an accuracy of the ML model, is below a predetermined accuracy threshold value.

In an embodiment, upon training the ML model, the ML model may be deployed to a cloud production environment. The cloud production environment may be any cloud computing platform, including at least one of: Amazon Web Services (AWS), Microsoft Azure, Google Cloud Platform (GCP), and the like. In an embodiment, the ML model may be deployed to the cloud production environment using any standard ML framework. For example, the ML model may be deployed using TensorFlow, PyTorch, scikit-learn, and the like.

FIG. 3 is a tabular view 300 depicting one or more datasets being extracted for analyzing payment patterns to predict which invoices should be closed when the remittance advice is missing, in accordance with another embodiment of the present disclosure. FIG. 3 depicts a table including the extracted one or more datasets that includes at least one of: the customer ID (alternatively referred as Customer number) representing the unique identifier for each entity, the invoice ID (alternatively referred as Invoice number) representing the unique identifier for each invoice, the invoice date representing the date when the invoice was created, the due date representing the expected payment date of the invoice, the payment header ID (referred as Payment_hdr_id) representing the unique payment identifier that links invoices to the payments, wherein some invoices may have this field filled (indicating that the payment reference exists), while other invoices may have it empty (indicating missing remittance details), the payment date representing the actual date when the payment was made, wherein if the invoice is unpaid, this field will be empty, and an “is open” field referring the binary indicator denoting whether the invoice is paid or not. The value of 0 indicates that the invoice has been paid, while the value of 1 means that the invoice remains open.

FIG. 4 is a tabular view 400 depicting the historical data, in accordance with another embodiment of the present disclosure. The historical data, as shown in FIG. 4 may include at least one of: a customer number referring an unique identifier for each customer/entity, a payment identifier representing a uniquely generated identifier for a payment event, a payment header ID representing a reference under which the payment was recorded, wherein there may be multiple payment header IDs linked to a single Payment ID, an invoice number representing an invoice that was considered for closure when the payment was received. The historical data further include an output with a binary indicator showing whether the invoice was successfully closed by the payment. The binary indicator 1 represents that the invoice was closed by the payment, and the binary indicator 0 represents that the invoice was not closed by the payment.

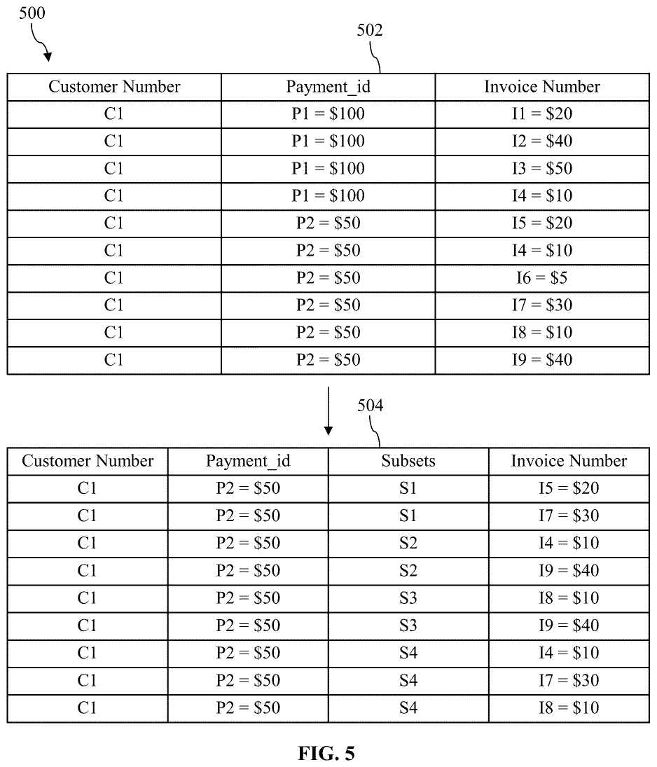

FIG. 5 is a tabular view 500 depicting one or more subsets generated to train the ML-model to automate future invoice closure predictions, in accordance with another embodiment of the present disclosure. The tabular view 500 shows that the subset sum model is configured to determine the one or more combinations of the one or more invoices that are used to close the one or more payments received from the one or more entities. For example, an input table 502 shows at least one of: customer number, payment ID, and invoice number. An output table 504 shows the one or more subsets (i.e., S1, S2, S3 and S4) with the one or more combinations of the one or more invoices matching the payment ID for closing the one or more payments received from the one or more entities.

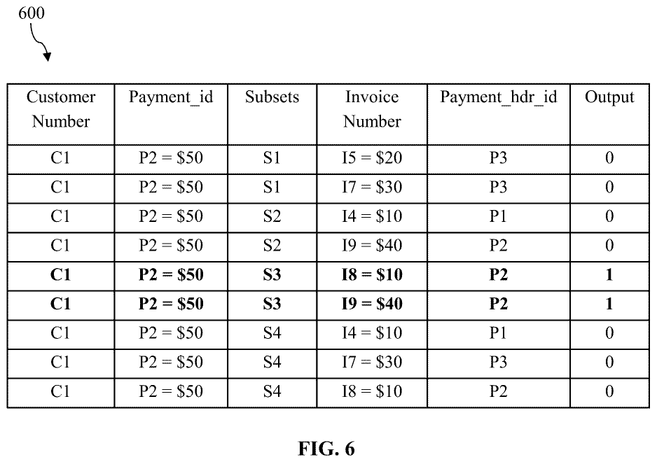

FIG. 6 is a tabular view 600 depicting validated one or more subsets, in accordance with another embodiment of the present disclosure. The tabular view 600 depicts the validated output that is stored in a structured format, showing the customer number, the payment ID, the one or more subsets of the one or more invoices considered, an individual invoice number, an associated payment header ID, and the binary indicator representing 1 for the one or more invoices that are closed and 0 for the one or more invoices that are not closed. The table 600 provides a clean and structured dataset for training the ML model, allowing it to learn from past payment behaviors.

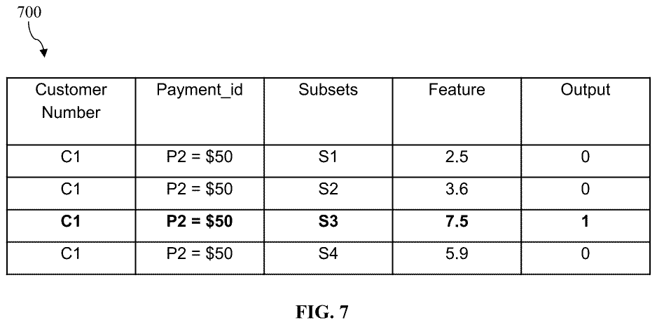

FIG. 7 is a tabular view 700 depicting integrated information associated with the one or more features of the one or more subsets to determine the one or more optimized subsets, for training the ML-model, in accordance with another embodiment of the present disclosure. The tabular view 700 shows that the optimized subset of the one or more invoices is determined among the one or more subsets of the invoices by integrating the information associated with the one or more features of the one or more subsets to determine the one or more optimized subsets. By integrating/rolling up the information associated with the one or more features of the one or more subsets, the ML-based system 104 is configured to reduce redundancy by selecting only the most relevant subset for each payment. The ML-based system 104 is configured to ensure that the machine learning model is trained only on valid invoice payment matches. The ML-based system 104 is configured to improve performance of the ML model by eliminating incorrect mappings before training the ML model.

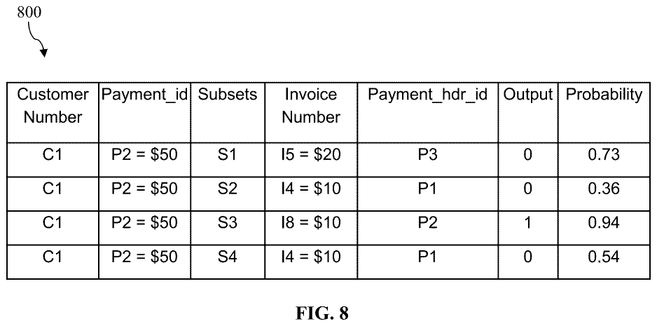

FIG. 8 is a tabular view 800 depicting the predicted one or more invoices for each payment received from the one or more entities, in accordance with another embodiment of the present disclosure. The tabular view 800 shows the final output that determines whether the one or more payments are correctly mapped to the one or more invoices, allowing for the automated invoice closure with minimum manual intervention. In this case, the method automatically predicts the invoices contain the following specific details, Customer Number: C1—Payment ID: P2=$50, Subset: S3, Invoice Number: 18=$10, Payment Header ID: P2. This invoice will be marked as closed for one or more payments received from one or more entities. This result will be outputted to the one or more users via one or more user interfaces. The output results, as shown in the table 800, are also used to compute accuracy and performance metrics and to guide potential refinements before deployment.

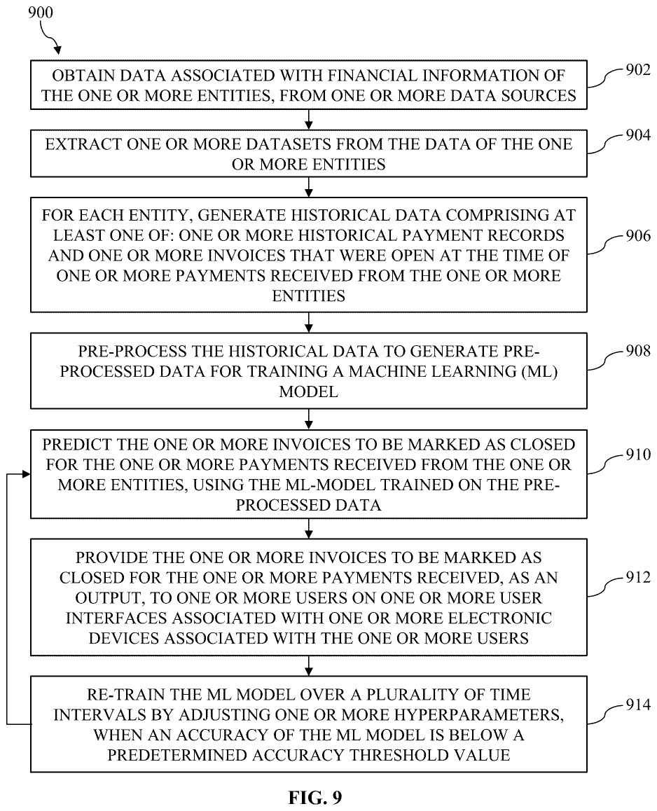

FIG. 9 is a flow chart illustrating a machine-learning based (ML-based) method 900 for automatically predicting the one or more invoices to be marked as closed for the one or more payments received from the one or more entities, in accordance with an embodiment of the present disclosure.

At step 902, the data associated with the financial information of the one or more entities are obtained from the one or more data sources (e.g., the one or more databases 108).

At step 904, the one or more datasets are extracted from the data of the one or more entities.

At step 906, for each entity, the historical data comprising at least one of: the one or more historical payment records and the one or more invoices that were open at the time the one or more payments received from the one or more entities, are generated.

At step 908, the historical data are pre-processed to generate the pre-processed data for training the ML-model.

At step 910, the one or more invoices to be marked as closed for the one or more payments received from the one or more entities, are predicted using the ML-model trained on the pre-processed data.

At step 912, the one or more invoices to be marked as closed for the one or more payments received, are provided as the output, to the one or more users on the one or more user interfaces associated with the one or more electronic devices 102 associated with the one or more users.

At step 914, the ML model is re-trained over a plurality of time intervals by adjusting one or more hyperparameters, when the accuracy of the ML model is below the predetermined accuracy threshold value.

The present invention has the following technical advantages. The present invention with the ML-based system 104 is configured to automatically predict the one or more invoices to be marked as closed for one or more payments received from the one or more entities. The present invention with the ML-based system 104 is configured to leverage the ML model to predict which invoices should be marked as closed when remittance details are missing. By analyzing historical remittance behavior, customer payment patterns, and invoice details, the ML-based system 104 automates the process of invoice reconciliation, improving efficiency and reducing manual effort. The ML-based system 104 is configured to utilize the ML model to analyze patterns in customer payments, transaction histories, and invoice attributes to intelligently predict invoice closure, even when remittance advice is absent.

The ML-based system 104 with the ML model is further configured to utilize the one or more features (i.e., the customer-level features and the one or more subset-level features) for predicting the invoice closure when the remittance advice is missing. The ML-based system 104 is further configured to roll up the one or more subsets to determine the optimized subset that best matches the payment, which results in at least one of: (a) reducing redundancy by selecting only the most relevant subset for each payment, (b) ensuring that the ML model is trained only on valid invoice-payment matches, and (c) improving the performance of the ML model by eliminating incorrect mappings before training the ML model.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 104 either directly or through intervening I/O controllers. Network adapters may also be coupled to the ML-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 104 in accordance with the embodiments herein. The ML-based system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 104. The ML-based system 104 can read the inventive instructions on the program storage devices and follow these instructions to execute the methodology of the embodiments herein.

The ML-based system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) method for automatically predicting one or more invoices to be marked as closed for one or more payments received from one or more entities, the ML-based method comprising:
obtaining, by one or more hardware processors, data associated with financial information of the one or more entities, from one or more data sources;
extracting, by the one or more hardware processors, one or more datasets from the data of the one or more entities;
for each entity, generating, by the one or more hardware processors, historical data comprising at least one of: one or more historical payment records and one or more invoices that were open at the time the one or more payments received from the one or more entities;
pre-processing, by the one or more hardware processors, the historical data to generate pre-processed data for training a ML-model;
predicting, by the one or more hardware processors, the one or more invoices to be marked as closed for the one or more payments received from the one or more entities, using the ML-model trained on the pre-processed data; and
providing, by the one or more hardware processors, the one or more invoices to be marked as closed for the one or more payments received, as an output, to one or more users on one or more user interfaces associated with one or more electronic devices associated with the one or more users.

2. The ML-based method of claim 1, wherein generating the historical data comprises:
extracting, by the one or more hardware processors, the one or more invoices that were open on or before payment date for each payment received from the one or more entities;
for each invoice, determining, by the one or more hardware processors, whether at least one of: the invoice date is on or before the payment date, and a recorded payment date is later than or equal to a payment due date;
adding, by the one or more hardware processors, the one or more invoices in the historical data upon determining whether at least one of: the invoice date is on or before the payment date, and the recorded payment date is greater than or equal to the payment due date; and
assigning, by the one or more hardware processors, one or more labels on the one or more invoices based on matching of one or more payment header identifiers associated with the one or more invoices, with one or more payment identifiers associated with the one or more payments received from the one or more entities,
wherein the one or more invoices are labelled as one or more closed invoices when the payment header identifiers match with the one or more payment identifiers, and wherein the one or more invoices are labelled as one or more open invoices when the payment header identifiers do not match with the one or more payment identifiers.

3. The ML-based method of claim 1, wherein generating the pre-processed data comprises generating, by the one or more hardware processors, one or more subsets of the one or more invoices, by:
extracting, by the one or more hardware processors, the one or more invoices that were open at the time the one or more payments received from the one or more entities;
identifying, by the one or more hardware processors, one or more combinations of the one or more invoices using a subset sum model, to obtain the one or more subsets having the identified one or more combinations of the one or more invoices;
selecting, by the one or more hardware processors, one or more optimized subsets from the one or more subsets based on a condition that a total sum of the one or more invoices within each of the one or more subsets is equal to the one or more payments received from the one or more entities, wherein one or more predefined rules are applied to select the one or more optimized subsets when multiple subsets of the one or more subsets fulfil the condition;
mapping, by the one or more hardware processors, one or more payment header identifiers associated with the selected one or more optimized subsets of the one or more invoices with the one or more payment identifiers associated with the one or more payments received from the one or more entities to validate whether the selected one or more optimized subsets of the one or more invoices match the one or more payments; and
labelling, by the one or more hardware processors, the one or more invoices in the one or more subsets, as closed when the one or more invoices in the one or more subsets are matched with the one or more payment identifiers.

4. The ML-based method of claim 3, wherein generating the pre-processed data further comprises extracting, by the one or more hardware processors, one or more features for each subset of the one or more invoices, from the historical data to train the ML model to learn one or more patterns corresponding to at least one of: the one or more payments and the one or more invoices closed for the one or more payments, and provide one or more insights,
wherein the one or more insights comprise at least one of: one or more payment behaviors patterns of the one or more entities, one or more grouping patterns associated with grouping of the one or more invoices, one or more delay trends, and variability in payments,
wherein the one or more features comprise at least one of: one or more customer-level features and one or more subset-level features.

5. The ML-based method of claim 3, further comprising:
integrating, by the one or more hardware processors, information associated with the one or more features of the one or more subsets to determine the one or more optimized subsets; and
utilizing, by the one or more hardware processors, the integrated information for training the ML model to predict the one or more invoices to be marked as closed for the one or more payments received from the one or more entities.

6. The ML-based method of claim 3, further comprising training, by the one or more hardware processors, the ML model, by:
splitting, by the one or more hardware processors, the one or more datasets associated with the one or more entities into at least one of: one or more training datasets and one or more testing datasets; and
training, by the one or more hardware processors, the ML model on the one or more training datasets to learn the one or more patterns using one or more hyperparameters, wherein the one or more hyperparameters comprises at least one of: n estimators indicating a number of trees in a forest model, a random state for result reproducibility, a class weight for learning invoice-payment mappings, an optimum depth to prevent overfitting, and an optimum feature to ensure diversity in decision-making.

7. The ML-based method of claim 1, further comprising evaluating, by the one or more hardware processors, performance of the ML model in predicting the one or more invoices to be marked as closed for the one or more payments received from the one or more entities, by:
assigning, by the one or more hardware processors, one or more probability scores to each subset of the one or more invoices;
selecting, by the one or more hardware processors, a subset with an optimum probability score as the predicted invoice for the payments; and
assessing, by the one or more hardware processors, an accuracy of the ML model, based on a number of correctly predicted payments and a total number of payments.

8. The ML-based method of claim 7, further comprising:
generating, by the one or more hardware processors, one or more evaluation reports providing one or more insights into the accuracy of performance of the ML model, wherein the one or more evaluation reports indicate at least one of: one or more error patterns, and error distribution across the one or more entities, and wherein the one or more evaluation reports are configured to identify types and sources of errors;
automatically generating, by the one or more hardware processors, one or more feedback in at least one of: real-time and periodic, on the one or more evaluation reports to provide one or more suggestions on the invoice-payment mapping process; and
monitoring, by the one or more hardware processors, performance of the ML model over time to determine one or more changes in accuracy metrics and error patterns.

9. A machine-learning based (ML-based) system for automatically predicting one or more invoices to be marked as closed for one or more payments received from one or more entities, the ML-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain data associated with financial information of the one or more entities, from one or more data sources;
a data extracting subsystem configured to extract one or more datasets from the data of the one or more entities;
a data generating subsystem configured to generate historical data for each entity, which comprise at least one of: one or more historical payment records and one or more invoices that were open at the time the one or more payments received from the one or more entities;
a data pre-processing subsystem configured to pre-process the historical data to generate pre-processed data for training a ML-model;
an invoice predicting subsystem configured to predict the one or more invoices to be marked as closed for the one or more payments received from the one or more entities, using the ML-model trained on the pre-processed data; and
an output subsystem configured to provide the one or more invoices to be marked as closed for the one or more payments received, as an output, to one or more users on one or more user interfaces associated with one or more electronic devices associated with the one or more users.

10. The ML-based system of claim 9, wherein in generating the historical data, the data generating subsystem is configured to:
extract the one or more invoices that were open on or before payment date for each payment received from the one or more entities;
for each invoice, determine whether at least one of: the invoice date is on or before the payment date, and a recorded payment date is later than or equal to a payment due date;
add the one or more invoices in the historical data upon determining whether at least one of: the invoice date is on or before the payment date, and the recorded payment date is greater than or equal to the payment due date; and
assign one or more labels on the one or more invoices based on matching of one or more payment header identifiers associated with the one or more invoices, with one or more payment identifiers associated with the one or more payments received from the one or more entities,
wherein the one or more invoices are labelled as one or more closed invoices when the payment header identifiers match with the one or more payment identifiers, and wherein the one or more invoices are labelled as one or more open invoices when the payment header identifiers do not match with the one or more payment identifiers.

11. The ML-based system of claim 9, wherein in generating the pre-processed data, the data pre-processing subsystem is configured to generate one or more subsets of the one or more invoices, by:
extracting the one or more invoices that were open at the time the one or more payments received from the one or more entities;
identifying one or more combinations of the one or more invoices using a subset sum model, to obtain the one or more subsets having the identified one or more combinations of the one or more invoices;
selecting one or more optimized subsets from the one or more subsets based on a condition that a total sum of the one or more invoices within each of the one or more subsets is equal to the one or more payments received from the one or more entities, wherein one or more predefined rules are applied to select the one or more optimized subsets when multiple subsets of the one or more subsets fulfil the condition;
mapping one or more payment header identifiers associated with the selected one or more optimized subsets of the one or more invoices with the one or more payment identifiers associated with the one or more payments received from the one or more entities to validate whether the selected one or more optimized subsets of the one or more invoices match the one or more payments; and
labelling the one or more invoices in the one or more subsets, as closed when the one or more invoices in the one or more subsets are matched with the one or more payment identifiers.

12. The ML-based system of claim 11, wherein in generating the pre-processed data, the data pre-processing subsystem is further configured to extract one or more features for each subset of the one or more invoices, from the historical data to train the ML model to learn one or more patterns corresponding to at least one of: the one or more payments and the one or more invoices closed for the one or more payments, and provide one or more insights,
wherein the one or more insights comprise at least one of: one or more payment behaviors patterns of the one or more entities, one or more grouping patterns associated with grouping of the one or more invoices, one or more delay trends, and variability in payments,
wherein the one or more features comprise at least one of: one or more customer-level features and one or more subset-level features.

13. The ML-based system of claim 11, further comprising a subset rolling subsystem configured to:
integrate information associated with the one or more features of the one or more subsets to determine the one or more optimized subsets; and
utilize the integrated information for training the ML model to predict the one or more invoices to be marked as closed for the one or more payments received from the one or more entities.

14. The ML-based system of claim 11, further comprising a training subsystem configured to train the ML model, by:
splitting the one or more datasets associated with the one or more entities into at least one of: one or more training datasets and one or more testing datasets; and
training the ML model on the one or more training datasets to learn the one or more patterns using one or more hyperparameters, wherein the one or more hyperparameters comprises at least one of: n estimators indicating a number of trees in a forest model, a random state for result reproducibility, a class weight for learning invoice-payment mappings, an optimum depth to prevent overfitting, and an optimum feature to ensure diversity in decision-making.

15. The ML-based system of claim 9, further comprising an accuracy assessment subsystem configured to evaluate performance of the ML model in predicting the one or more invoices to be marked as closed for the one or more payments received from the one or more entities, by:
assigning one or more probability scores to each subset of the one or more invoices;
selecting a subset with an optimum probability score as the predicted invoice for the payments; and
assessing an accuracy of the ML model, based on a number of correctly predicted payments and a total number of payments.

16. The ML-based system of claim 15, wherein the accuracy assessment subsystem is further configured to:
generate one or more evaluation reports providing one or more insights into the accuracy of performance of the ML model, wherein the one or more evaluation reports indicate at least one of: one or more error patterns, and error distribution across the one or more entities, and wherein the one or more evaluation reports are configured to identify types and sources of errors;
automatically generate one or more feedback in at least one of: real-time and periodic, on the one or more evaluation reports to provide one or more suggestions on the invoice-payment mapping process; and
monitor performance of the ML model over time to determine one or more changes in accuracy metrics and error patterns.

17. A non-transitory computer-readable storage medium having instructions stored therein that when executed by one or more hardware processors, cause the one or more hardware processors to execute operations of:
obtaining data associated with financial information of the one or more entities, from one or more data sources;
extracting one or more datasets from the data of the one or more entities;
for each entity, generating historical data comprising at least one of: one or more historical payment records and one or more invoices that were open at the time of one or more payments received from the one or more entities;
pre-processing the historical data to generate pre-processed data for training a machine learning (ML) model;
predicting the one or more invoices to be marked as closed for the one or more payments received from the one or more entities, using the ML-model trained on the pre-processed data; and
providing the one or more invoices to be marked as closed for the one or more payments received, as an output, to one or more users on one or more user interfaces associated with one or more electronic devices associated with the one or more users.

18. The non-transitory computer-readable storage medium of claim 17, wherein generating the pre-processed data comprises generating one or more subsets of the one or more invoices, by:
extracting the one or more invoices that were open at the time the one or more payments received from the one or more entities;
identifying one or more combinations of the one or more invoices using a subset sum model, to obtain the one or more subsets having the identified one or more combinations of the one or more invoices;
selecting one or more optimized subsets from the one or more subsets based on a condition that a total sum of the one or more invoices within each of the one or more subsets is equal to the one or more payments received from the one or more entities, wherein one or more predefined rules are applied to select the one or more optimized subsets when multiple subsets of the one or more subsets fulfil the condition;
mapping one or more payment header identifiers associated with the selected one or more optimized subsets of the one or more invoices with the one or more payment identifiers associated with the one or more payments received from the one or more entities to validate whether the selected one or more optimized subsets of the one or more invoices match the one or more payments; and
labelling the one or more invoices in the one or more subsets, as closed when the one or more invoices in the one or more subsets are matched with the one or more payment identifiers.

19. The non-transitory computer-readable storage medium of claim 18, wherein generating the pre-processed data further comprises extracting, by the one or more hardware processors, one or more features for each subset of the one or more invoices, from the historical data to train the ML model to learn one or more patterns corresponding to at least one of: the one or more payments and the one or more invoices closed for the one or more payments, and provide one or more insights,
wherein the one or more insights comprise at least one of: one or more payment behaviors patterns of the one or more entities, one or more grouping patterns associated with grouping of the one or more invoices, one or more delay trends, and variability in payments,
wherein the one or more features comprise at least one of: one or more customer-level features and one or more subset-level features.

20. The non-transitory computer-readable storage medium of claim 18, further comprising training the ML model, by:
splitting the one or more datasets associated with the one or more entities into at least one of: one or more training datasets and one or more testing datasets; and
training the ML model on the one or more training datasets to learn one or more patterns using one or more hyperparameters, wherein the one or more hyperparameters comprises at least one of: n estimators indicating a number of trees in a forest model, a random state for result reproducibility, a class weight for learning invoice-payment mappings, an optimum depth to prevent overfitting, and an optimum feature to ensure diversity in decision-making.
